(19) United States
(12) Patent Application Publication
(10) Pub. No.: US 2013/0112136 A1
(43) Pub. Date: May 9, 2013

(54) DEVICE FOR APPLYING FLUID MEDIA

(71) Applicant: Heinrich Mensing, Langen (DE)

(72) Inventor: Heinrich Mensing, Langen (DE)

(21) Appl. No.: 13/810,704

(22) PCT Filed: Jul. 20, 2011
(86) PCT No.: PCT/EP2011/062446

§ 371 Date: Jan. 17, 2013

(30) Foreign Application Priority Data
Jul. 20, 2010 (DE) 10 2010 031 824.8

(51) Int. Cl. B05C 11/02

(52) U.S. Cl. CPC B05C 11/023
USPC 118/101; 118/103

(57) ABSTRACT

The invention relates to a device for applying fluid media to material that is moved in a web-like manner, in particular for applying hot-melt adhesive (4) to a textile material, and in particular for reinforcing the back of a carpet or a synthetic turf (1), comprising a gap-shaped application region (3), for the medium (4), which extends transversely to the web direction and is delimited in the transport direction of the web (1) by a trailing doctor blade (7) facing the surface of the web (1). According to the invention, a smoothing contour (8) cooperating with the applied medium (4) is provided downstream of the doctor blade (7) in the transport direction of the web (1).

The invention relates to a device for applying fluid media in accordance with the generic features indicated in the device claim.

When producing a carpet by the tufting method, the fibers forming the pile are introduced into a support layer, and the pile naps and respectively pile loops on the back side of the carpet will then still have to be fixed. For this purpose, it is known to coat the back side with latex material. Further, for fixing and anchoring the pile naps, it is known to apply a synthetic material onto the back side of the carpet. It is also possible to apply onto the back side a further layer as a secondary back layer. A method for coating the back side of a carpet is known from DE 10 2005 060 450 A1.

Reinforcing the back side of a carpet or another textile fabric by means of a hot-melt adhesive and with use of a wide-slot nozzle, is known from DE 10 2008 045 753 A1, DE 10 2008 010 091 A1 as well as DE 10 2008 020 716 A1. The hot-melt adhesive is brought to a temperature at which it will have a viscosity allowing for penetration into the fiber material of the back-side fabric and/or of the pile loops, and/or into the structure of the composite fabric (back side and pile loops).

One embodiment of a wide-slot nozzle is shown in U.S. Pat. No. 4,867,982. The slot nozzle comprises a doctor blade (scraper) trailing in the transport direction of the material which is to be coated. By means of this doctor blade, the coating material will be applied. The quality and the quantity of the coating are highly dependent on the adjustment position of said doctor blade relative to the to-be-coated material.

A wide-slot nozzle wherein the dosage of the coating medium can be set differently for various zones across the width of the material is described in EP 0 568 812 B1. The application slot of this nozzle is formed by two solid nozzle bodies. The end regions of the nozzle bodies, surrounding the application slot, have different shapes and each form a respective leading edge and a respective trailing edge in the transport direction of the material which is to be coated.

DE 10 2007 056 121 B3 discloses a wide-slot nozzle which again is formed by two nozzle bodies. The nozzle bodies are adjustable and respectively pivotable relative to each other, thus making it possible, by corresponding selection of the gap width, to set the dose of the medium to be applied. The end regions of the nozzle bodies, arranged in sliding contact with the web which is to be coated, are rounded in different shapes and, in principle, when seen in the transport direction of the to-be-coated material, they represent two doctor blades applied in negative orientation.

The application device for hot-melt adhesives according to EP 1 752 506 A1 uses a wide-slot nozzle wherein the application region (gap) is delimited by two nozzle bodies. The nozzle body end regions contacting the to-be-coated material have an areal shape and will effect a certain compression of the material in the coating region. The force of the corresponding counter pressure is exerted on the to-be-coated material by means a sliding support and respectively a rotating transport roller.

U.S. Pat. No. 4,688,516 discloses an application unit comprising a multi-chamber system and two doctor blades which are adjustable for dosing. The medium which is to be coated will be supplied in a first chamber, and excess material will be caught in a trailing chamber and be returned again. This arrangement is complex and also does not allow for a free choice of the installation position.

Thus, the invention starts from a device for applying fluid media onto material being moved in a web-like manner, in particular for applying hot-melt adhesive onto a textile material, and in particular for reinforcing the back of a carpet or a synthetic turf, comprising a gap-shaped application region for the medium, which extends transversely to the web direction and is delimited in the transport direction of the web by a trailing doctor blade facing the surface of the web.

It is an object of the present invention to further develop such a device and particularly to improve the quality of the application, the coating.

The above object is to be achieved by the features of the device claim. Advantageous modified embodiments of the invention are defined in the subclaims.

According to the invention, it is provided that a smoothing contour cooperating with the applied medium is arranged downstream of the doctor blade in the transport direction of the web.

The application region for the medium, formed as a wide-slot nozzle, is delimited by a trailing doctor blade which relative to the moving web surface can be arranged at a positive or negative orientation. In this configuration, the edge of the doctor blade will spread the to-be-applied adhesive over the web surface, i.e. the material which is to be coated, and will thus dose the applied quantity. The smoothing contour which is provided according to the invention and is arranged downstream of the doctor blade, will additionally distribute, smoothen and process the applied adhesive. Inhomogeneities in the thickness of the application will be homogenized, and the penetration of the adhesive into the structure of the web material will be improved.

As further measures, it can thus be provided that:
The smoothing contour is a part of a bar extending parallel to the doctor blade.
The smoothing contour is a part of a structure formed to the doctor blade.
The smoothing contour is a part of a housing supporting the doctor blade.
The smoothing contour is adjustable, with the aid of adjusting means, relative to the doctor blade upstream of the smoothing contour and thus relative to the surface of the article.
The distance from the smoothing contour to the surface of the article is adjustable.
The angular position of the smoothing contour relative to the surface of the article is adjustable.
The smoothing contour has heating device assigned to it.
The smoothing contour comprises a coating and respectively is made of a material which is hardly wettable by the hot-melt adhesive in the molten state of the adhesive.

The invention can be realized with particular advantage if the smoothing contour is provided with a material which is hardly wettable by the hot-melt adhesive. The smoothing contour, formed as a bar, can be made of a corresponding material.

According to a further advantageous embodiment of the invention, it is possible to provide the smoothing contour with a heating device by which the smoothing contour (its surface which is in contact with the hot-melt adhesive) can be heated. The heating device is e.g. an electrically operated control unit which effects the heating by means of heating coils integrated into the bar. For this purpose, there is preferably selected a temperature which corresponds to the melting temperature of the hot-melt adhesive. Thereby, adhesion of the hot-melt adhesive to the body of the smoothing contour is avoided, and the smoothing effect and the incorporation of the adhesive substance into the fabric structure of the article are improved.

Preferably, the smoothing contour, the corresponding bar and respectively the support structure of the bar are provided with an adjustment device so that the smoothing contour is adjustable relative to the doctor blade up-stream thereof and thus also relative to the article (surface of the adhesive layer), as required depending on the respective conditions. Thus, a stronger application against the article will result in a stronger rub-in effect of the hot-melt adhesive into the fabric structure. A too strong application, on the other hand, should be avoided because, otherwise, the smoothing contour would scrape off the hot-melt adhesive. With the aid of a suitably designed adjustment device, it is possible to change not only the distance from the smoothing contour to the surface of the article but also the orientation and inclination of the smoothing contour.

Hereunder, an exemplary embodiment will be explained with reference to the drawing.

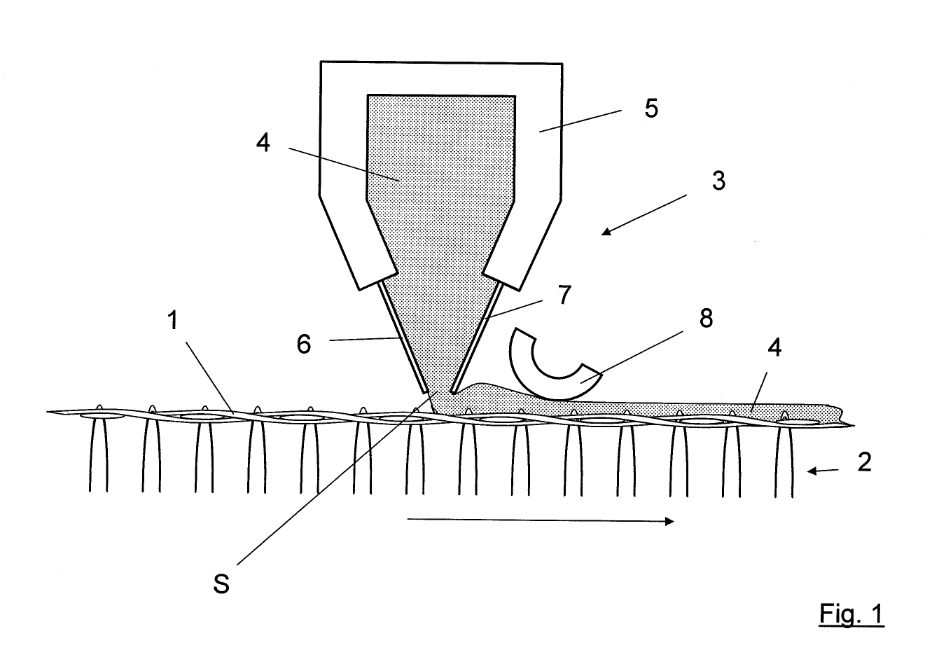

FIG. 1 shows an embodiment of the invention. A web-like carpet 1 and respectively artificial turf, with its pile side 2 facing downward, is passed by a wide-slot nozzle 3 extending across the width of the material web. The direction of the movement of the material web 1 is marked by the arrow. Via said wide-slot nozzle 3, hot-melt adhesive 4 which has been liquefied by heating is applied onto the back side of the article. By said hot-melt adhesive 4, the pile loops (pile side 2) tufted into the back surface (the fabric) will be fixed after the adhesive has cooled.

The wide-slot nozzle 3 comprises a housing 5 formed as a hollow body and being open in downward direction, which in its interior forms a chamber and can be supplied by molten hot-melt adhesive 4 via feed conduits, not shown. On the bottom side of housing 5, two doctor blades 6,7 are arranged which extend at an angle relative to each other, a dosing gap S being formed by those ends of the blades which are facing toward the article 1. With the aid of elements not illustrated here, the doctor blades 6,7 can be adjusted relative to each other, which, on the whole, allows for dosability in dependence on the viscosity of the hot-melt adhesive 4 which is to be processed, and on the quantity (weight per unit area) to be applied onto the article 1. Relative to the transport direction of the article 1, one doctor blade 6 is arranged in a positive orientation and the other doctor blade 7 is arranged in a negative orientation. Ultimately, also the wide-slot nozzle 3 in its entirety is adjustable relative to the article 1, i.e. there can be adjusted the pressure of the nozzle 3 relative to the moving article 1. In this case, depending on the respective use, the article 1 can be guided in a tensioned state via a rotating cylinder or a via two mutually spaced rollers.

Downstream of the doctor blade 7 which trails in the transport direction of article 1 and is arranged in a negative orientation, a smoothing contour 8 is disposed which in the embodiment depicted herein is formed as a bar having a semicircular shape in downward direction, said bar being arranged parallel to the wide-slot nozzle 3 and extending along the length of the nozzle. Via attachment elements, not shown, said bar 8 is connected to wide-slot nozzle 3 and particularly is also adjustable relative to wide-slot nozzle 3 by adjustment means.

By means of the smoothing contour 8, the hot-melt adhesive 4, being applied onto the article 1 in a dosed manner by the doctor blades 6,7, will additionally be evenly distributed and smoothed. Particularly, in this manner, corrugations and grooves are avoided. Further, possibly generated blisters will be destroyed and, ultimately, with corresponding orientation of the smoothing contour 8 relative to the article, there will be obtained an improved penetration of the hot-melt adhesive 4 into the fabric structure of article 1.

### LIST OF REFERENCE NUMERALS

1 Article, web, carpet, artificial turf

2 Pile side, pile loops

3 Nozzle, wide-slot nozzle

4 Adhesive, hot-melt adhesive, hot-melt adhesive film

5 Housing

6 Doctor blade

7 Doctor blade

8 Smoothing contour, bar

9 S Dosing gap, gap

1-9. (canceled)

10. A device for applying fluid media onto material being moved in a web-like manner, in particular for applying hot-melt adhesive onto a textile material, and in particular for reinforcing the back of a carpet or a synthetic turf, comprising a gap-shaped application region for the medium, which extends transversely to the web direction and is delimited in the transport direction of the web by a trailing doctor blade facing the surface of the web, wherein
a smoothing contour cooperating with the applied medium is arranged downstream of the doctor blade in the transport direction of the web.

11. The device according to claim 10, wherein the smoothing contour is a part of a bar extending parallel to the doctor blade.

12. The device according to claim 10, wherein the smoothing contour is a part of a structure formed to the doctor blade.

13. The device according to claim 10, wherein the smoothing contour is a part of a housing supporting the doctor blade.

14. The device according to claim 10, wherein the smoothing contour is adjustable, with the aid of adjusting means, relative to the doctor blade upstream of the smoothing contour and thus relative to the surface of the article.

15. The device according to claim 14, wherein the distance from the smoothing contour to the surface of the article is adjustable.

16. The device according to claim 14, wherein the angular position of the smoothing contour relative to the surface of the article is adjustable.

17. The device according to claim 10, wherein the smoothing contour has heating device assigned to it.

18. The device according to claim 10, wherein the smoothing contour comprises a coating and respectively is made of a material which is hardly wettable by the hot-melt adhesive in the molten state of the adhesive.
